(19) United States
(12) Patent Application Publication
(10) Pub. No.: US 2026/0140032 A1
(43) Pub. Date: May 21, 2026

(54) A METHOD AND AN ASSEMBLY FOR MEASURING PARTICLE SIZE OF PARTICLES SUSPENDED IN A FLUID

(71) Applicant: Spec-Imaging AB, Lund (SE)

(72) Inventors: Edouard Jean Jacques BERROCAL, Lund (SE); Elias Viktor KRISTENSSON, Bjärred (SE)

(21) Appl. No.: 19/119,429

(22) PCT Filed: Oct. 24, 2023
(86) PCT No.: PCT/SE2023/051048

§ 371 Date: Apr. 9, 2025

(30) Foreign Application Priority Data
Oct. 24, 2022 (SE) 2251236-2

(51) Int. Cl. G01N 15/0205

(52) U.S. Cl. CPC G01N 15/0211

(57) ABSTRACT

The disclosure relates to a method for measuring particle size of particles suspended in a fluid, the method comprising modulating (S1) radiation with a periodic wave optical mask; illuminating (S2) the fluid with the modulated radiation; detecting scattered radiation and/or transmitted radiation (S3-1) with a 2D detector capturing an image at a first modulation frequency; detecting scattered radiation and/or transmitted radiation (S3-2) with a 2D detector capturing an image at a second modulation frequency; extracting (S4) a first image for the first modulation frequency and a second image for the second modulation frequency, respectively; calculating(S5) a first extinction coefficient for the first modulation frequency and the second modulation frequency, respectively, based on the first extracted image and the second extracted image, respectively; determining the size (S7) of the suspended particles based on the relationship between the first calculated extinction coefficient and the second calculated extinction coefficient. The disclosure further relates to an assembly for measuring particle size of particles suspended in a fluid.

### TECHNICAL FIELD

The present disclosure relates to a method for measuring particle size of particles suspended in a fluid and an assembly for measuring particle size of particles suspended in a fluid as defined in the introductory parts of the independent claims.

### BACKGROUND ART

Measuring the amount of particles suspended in water is important for determining water quality in different situations. Total Suspended Solids (TSS) is the amount of fine particles suspended in water. The TSS is an indication if the water is pure or not. Unclear water is in many situations un-wanted and/or unhealthy. To monitor water quality measurements of TSS is needed regularly. To investigate particles suspended in water cumbersome measurement procedures are, however, needed. Often the sample is diluted and the measurements are slow, demanding and expensive. There is thus a need for improved ways of measuring the amount and size of particles suspended in water.

### SUMMARY

It is an object of the present disclosure to mitigate, alleviate or eliminate one or more of the above-identified deficiencies and disadvantages in the prior art and solve at least the above mentioned problem. According to a first aspect there is provided a method for measuring particle size of particles suspended in a fluid, the method comprising modulating radiation with a periodic wave optical mask; illuminating the fluid with the spatially modulated radiation; detecting scattered radiation and/or transmitted radiation with a 2D detector capturing an image at a first modulation frequency; detecting scattered radiation and/or transmitted radiation with a 2D detector capturing an image at a second modulation frequency; extracting a first image for the first modulation frequency and a second image for the second modulation frequency, respectively; calculating a first extinction coefficient for the first modulation frequency and the second modulation frequency, respectively, based on the first extracted image and the second extracted image, respectively; determining the size of the suspended particles based on the relationship between the first calculated extinction coefficient and the second calculated extinction coefficient.

An advantage with this measurement is that it is fast and does not require any intervention with the measurement sample as e.g. dilution or waiting on sedimentation. The measurement is also possible to do on site where measurements are needed and could be made as an in-line solution for regular monitoring of a water volume.

The whole measurement is completed fast, as only two images need to be captured at two different modulation frequencies.

An examples of a measurement where the method is especially beneficial is a measurement for measuring water quality. However, the method can be applied to suspended particles in any fluid transparent for the radiation used. The radiation is light for measurement on suspended particles in water. However, for other fluids, other radiation types could be contemplated based on the absorption spectrum of the fluid in question. The fluid could be a liquid or a gas and particles are to be interpreted broad and could be any small solid entity or a drop, droplet or aerosol of a liquid.

According to some embodiments measurements the relationship between the first calculated extinction coefficient and the second calculated extinction coefficient is a difference. The determination is performed by comparing the difference to a pre-calibrated table or calibration curve.

According to some embodiments measurements the relationship between the first calculated extinction coefficient and the second calculated extinction coefficient is a ratio. The determination is performed by comparing the ratio to a pre-calibrated table or calibration curve.

According to some embodiments measurements are made at multiple frequencies instead of two with corresponding following steps. An advantage is that the accuracy and/or precision of the determination of size of the suspended particles can be enhanced.

According to some embodiments, the method further comprises: calculating a true extinction coefficient based on the calculated extinction coefficients; estimating the number density of the suspended particles based on the determined size of the suspended particles and the true extinction coefficient.

An advantage with this embodiment is that the number density can be estimated providing further information needed for determining the fluid quality in view of suspended particles.

According to some embodiments, the method further comprises: calculating the Total Suspended Solids Volume of the suspended particles based on the estimated number density and the determined size of the suspended particles.

An advantage with this embodiment is that a value of the Total Suspended Solids Volume (TSSV) is provided, which is an important value for estimating fluid quality in view of suspended particles.

According to some embodiments, the method comprises calculating the dry weight based on the TSSV and the density of the particles.

An advantage with this embodiment is that a value of the dry weight is provided, which is an important value for estimating fluid quality in view of suspended particles.

According to some embodiments, the method comprises repeating the method multiple times over time to measure the particle sedimentation and estimate the density based on the particle sedimentation.

An advantage with this embodiment is that the accuracy of the density measurement is further increased.

According to some embodiments, the periodic wave optical mask is comprised in the group consisting of: square wave mask/pattern; sine wave mask/pattern or a diffractive optical element.

According to some embodiments, the method further comprises generating the multiple modulation frequencies by illuminating multiple masks with different frequencies (two or more frequencies) sequentially. This is a relatively simple and fast way of achieving the measurement method and produce the measurement result.

According to some embodiments, the multiples masks are placed on the same base plate, the method further the method comprises: moving the base plate to sequentially shift the mask used for modulating the radiation.

An advantage with this is that it is a simple, robust and fast way to achieve the multiple frequencies of the modulated radiation for illuminating the fluid with.

According to some embodiments, the method further comprises generating the multiple modulation frequencies by extracting different harmonics in the modulation using a fast Fourier transform method.

An advantage with this embodiment is that moving parts can be avoided making it possible to make the measurement equipment even more robust as the measurement is performed with a single recording and without the need of moving an optical mask.

According to some embodiments, the scattering is side-scattering detected from the side by the 2D detector.

An advantage with this embodiment is that a two-dimensional (2D) image can be taken and the extinction of the signal can be viewed along the x-axis in the captured image.

According to some embodiments, the mask is a square wave mask and wherein the harmonics are separated by a one-dimensional power spectrum and spatial lock-in analysis.

An advantage with this embodiment is that the multiple frequencies of the modulated radiation for illuminating the fluid can be measured in one image without the need of sequential measurements making the measurement truly instantaneous.

According to some embodiments, the scattering is forward-scattering detected by the 2D-detector along the radiation propagation direction after the liquid.

An advantage of this embodiment is that the measurement may be setup in line without the need to measure from the side.

According to some embodiments, the mask is a square wave mask and wherein the harmonics are separated by a two-dimensional power spectrum (Fourier transform) and spatial lock-in analysis.

An advantage with this embodiment is that the multiple frequencies of the modulated radiation for illuminating the fluid can be measured in one image without the need of sequential measurements making the measurement truly instantaneous.

According to a second aspect there is provided A method for measuring particle size of particles suspended in a fluid, the method comprising modulating radiation with a periodic wave optical mask; illuminating the fluid with the modulated radiation; detecting scattered radiation and/or transmitted radiation with a 2D detector capturing an image at a first radiation wavelength; detecting scattered radiation and/or transmitted radiation with a 2D detector capturing an image at a second radiation wavelength; extracting a first image for the first radiation wavelength and a second image for the second radiation wavelength, respectively; calculating a first extinction coefficient for the first radiation wavelength and the radiation wavelength, respectively, based on the first extracted image and the second extracted image, respectively; determining the size of the suspended particles based on the relationship between the first calculated extinction coefficient and the second calculated extinction coefficient.

The second aspect is intended for measuring particle sizes below roughly one micrometer. Then two or more wavelengths can be used and only one modulation frequency instead of using two modulation frequencies analogous to the method according to the first aspect. The Rayleigh scattering will vary dependent on wavelength in comparison to how the Lorenz-Mie scattering from bigger particles differ dependent on modulation frequency as explained in connection to the first aspect. By combining two wavelengths, or colors, of radiation in the same modulated light sheet (e.g. the top half with a long wavelength in the red or IR region and the bottom half with a short wavelength in the blue or UV region), the measurement can be made in one single camera shot of the side scattering.

According to a second aspect there is provided an assembly for measuring particle size of particles suspended in a fluid, the assembly comprising: a radiation profile generator configured to provide a radiation profile wherein the radiation profile has a propagation path in a second spatial dimension ; a periodic wave optical mask arranged to modulate the radiation profile; a holder for a sample of the medium, configured to enable the intensity modulated radiation sheet to illuminate the sample; and a 2D detector arranged to capture at last one 2D image for each of a plurality of modulation frequencies; wherein the assembly is arranged to perform the method according to the first aspect.

An advantage with the assembly is that it is robust and capable of fast, and according to some embodiments also instantaneous, accurate measurements of size, density or TSSV of particles suspended in fluids.

According to some embodiments, the radiation profile generator is configured to provide a polychromatic radiation sheet comprising a radiation spectrum extending in a first spatial dimension. An advantage is that a 2D image can be recorded from the side to observe and measure the extinction of the radiation as it propagates through the fluid with suspended particles. This is particularly useful when measuring particle sizes below roughly one micrometer. Then two or more wavelengths can be used and only one modulation frequency instead of using two modulation frequencies analogous to the method according to the first aspect. The Rayleigh scattering will vary dependent on wavelength in comparison to how the Lorenz-Mie scattering from bigger particles differ dependent on modulation frequency as explained in connection to the first aspect.

Effects and features of the second and third aspects are to a large extent analogous to those described above in connection with the first aspect. Embodiments mentioned in relation to the first aspect are largely compatible with the second and third aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a shows a schematic side view illustrating an example assembly according to some embodiments of the present disclosure.

FIG. 1b shows a schematic top view illustrating the example assembly of FIG. 1a.

FIG. 2a shows the signal intensity as a function of penetration length through a sample with suspended particles of three different sizes and at two different frequencies.

FIG. 2b shows the signal intensity disclosed in FIG. 3a but on a logarithmic scale for the two different frequencies.

FIG. 2c is a plot of the linear regression coefficients of the lines disclosed in FIG. 3b for the two different frequencies.

FIG. 3a illustrates the method of the present disclosure by measuring the extinction coefficient at two different frequencies by sequential phase shift, 2D imaging of side scattering and subtraction of the images.

FIG. 3b illustrates the method of the present disclosure by measuring the extinction coefficient at two different frequencies by a single mask with two frequencies, 2D imaging of side scattering and FFT analysis to extract the extinction coefficient from the first harmonic.

FIG. 3c is a schematic illustration if the setup used for the embodiments disclosed in FIGS. 3a and 3b.

FIG. 3d is a schematic illustration of the present disclosure by measuring the extinction coefficient at a single frequency and phase by a single mask, 2D imaging of side scattering and FFT analysis to extract the extinction coefficient from the first and second harmonic.

FIG. 4a illustrates the method of the present disclosure by measuring the extinction coefficient at two different frequencies by sequential phase shift, imaging of transmitted and forward scattered light and subtraction of the images.

FIG. 4b illustrates the method of the present disclosure by measuring the extinction coefficient at two different frequencies by a single mask per frequency, imaging of transmitted and forward scattered light and FFT analysis to extract the extinction coefficient from the first harmonic.

FIG. 4c is a schematic illustration if the setup used for the embodiments disclosed in FIG. 4b.

FIG. 5 illustrates the method of the present disclosure by measuring the extinction coefficient using modulated light of a single frequency but at two different wavelengths, 2D imaging of side scattering and calculation of the extinction for each wavelength.

FIG. 6 shows is a flowchart illustrating example method steps according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

Many conventional approaches to spectrophotometric measurements uses successively applied monochromatic beams to illuminate the sample of the medium under examination. To acquire information for more than one wavelength, a scan through all wavelengths of interest needs to be performed. Such approaches may be inefficient for performing measurements.

In the following, embodiments will be described whereby efficient and accurate measurements are enabled. Furthermore, some embodiments provide increased flexibility in measuring optical properties of the medium under examination. Thereby, accurate measurements can be carried out by the same assembly for media having a wide range of various optical properties.

Also generally, the term “optical parameters” may refer to any suitable optical parameter describing an optical property; such as, for example, an absorption coefficient, an attenuation coefficient (a.k.a. an extinction coefficient), a scattering coefficient, a fluorescence quantum yield (QY), a phosphorescence quantum yield (QY), etc. The extinction coefficient equals the sum of the absorption coefficient and the scattering coefficient. Other examples of optical properties include properties linked to one or more of: a concentration, an averaged cross-section, and a particle size (if there are particles in the medium). Thus, these parameters may also be derived. Hence, measuring an optical parameter may be defined as measuring an (the corresponding) optical property.

Also generally, exemplification by scattering is meant to be relevant also for emission of photoluminescing media, and vice versa.

Also generally, the term “light” refers to electromagnetic radiation having a wavelength within a certain range. This range may comprise what is commonly referred to as visible light (i.e., a portion of the electromagnetic radiation spectrum that is visible to the human eye). Alternatively or additionally, this range may comprise what is commonly referred to as non-visible light (i.e., a portion of the electromagnetic radiation spectrum that is not visible to the human eye), for example infrared (IR) light and/or ultraviolet (UV) light. The term “illumination” refers to irradiation by light as defined above.

Also generally, the term “polychromatic” describes something comprising two or more (visible or non-visible) wavelengths of the electromagnetic radiation spectrum.

Also generally, the term (single) optical sensor may refer to an array/matrix of constituent optical sensors (such as a digital camera where each pixel has a corresponding constituent optical sensor; an optical detector) or to a single optical sensor element (a single optical detector) that is configured to sweep over a recording area.

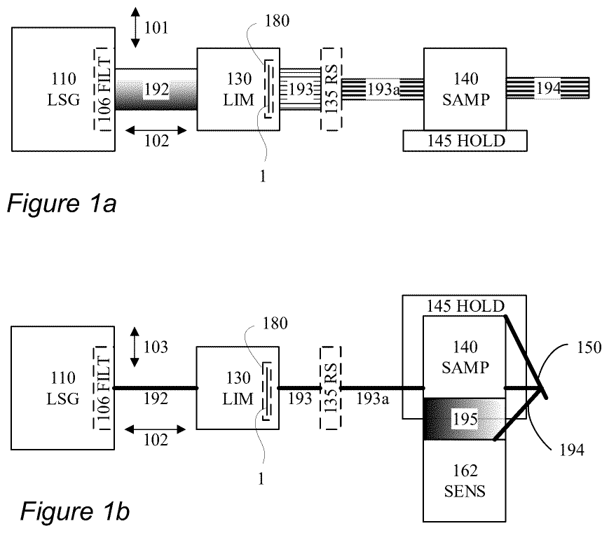

FIG. 1 schematically illustrates an example assembly according to some embodiments, for measurements of one or more optical parameters of a medium. Part (a) illustrates a side wave of one variant of the assembly and part (b) illustrate a top views of the assembly.

The assembly comprises a light sheet generator (LSG) 110, a light intensity modulator (LIM) 130, a holder (HOLD) 145 for a sample (SAMP) 140 of the medium, and an optical sensor (SENS) 161, 162.

The light sheet generator 110 is configured to provide a monochromatic or polychromatic light sheet 192, and has a propagation path in a second spatial dimension 102.

The second spatial dimension is non-parallel (typically orthogonal) to the first spatial dimension (e.g., in Euclidean coordinates). Together with a third spatial dimension 103 (which is non-parallel, typically orthogonal, to the first spatial dimension and to the second spatial dimension), the first and second spatial dimension spans a three-dimensional space. The terms “spatial dimension” and “dimension” will be used interchangeably herein.

A light sheet may, for example, be defined as light propagating along two or more paths in a single plane (e.g., in Euclidean coordinates).

That the light spectrum extends in the first spatial dimension may be understood as a light wavelength variation, which has the property that each coordinate along a path in the first spatial dimension experiences at most one wavelength of light.

The light intensity modulator (LIM) 130 comprises an optical holder 180 holding a grating 1 for modulating the light sheet 192. The light intensity modulator 130 is configured to provide an intensity modulated light sheet 193, 193a by applying (to the light sheet) an intensity modulation having a periodical—or substantially periodical—pattern in the first spatial dimension.

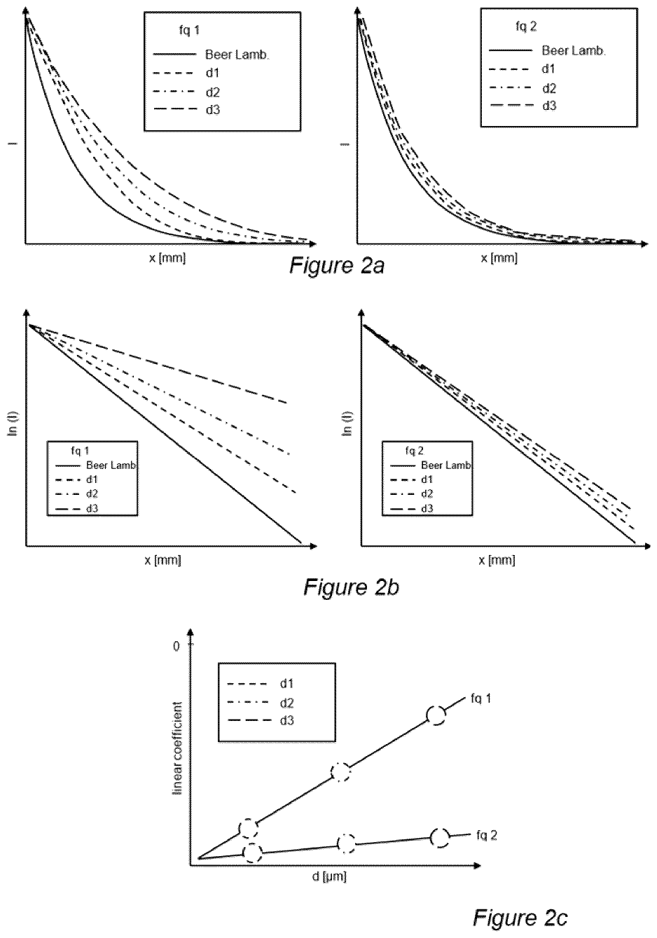

Examples of periodical patterns include patterns defined by a Ronchi ruling—i.e., a constant-interval bar and space square wave (e.g., equaling a when 2kb≤x<(2k+1)b, and equaling c when (2k+1)b≤x<(2k+2)b, kϵZ) as shown in FIG. 2—and patterns defined by a sinusoidal function. Examples of substantially periodical patterns include any pattern that alters between values below its mean value and values above its mean value in a certain periodicity over x, but where the values below its mean value and/or the values above its mean value can be different for different periods. Another example of a substantially periodical pattern is a pattern with a slight periodicity shift along x. Further periodic patterns may thereby be triangular masks, or any periodical pattern mask.

Referring again to FIGS. 1a and 1b, the second aspect of this disclosure shows an assembly for measurements of one or more optical parameters of a medium, the assembly comprising: a light profile generator the first aspect configured to provide a light profile, wherein the light profile has a propagation path in a second spatial dimension 102; a light intensity modulator 130 configured to provide an intensity modulated light profile 193,193a by applying—to the light profile—an intensity modulation having a periodical, or substantially periodical, pattern in the first spatial dimension; a holder 145 for a sample 140 of the medium, configured to enable the intensity modulated light sheet to illuminate the sample; and an optical sensor 161,162 configured to record intensity of light 194,195 exiting the sample over the light spectrum for provision of the one or more optical parameters; wherein light intensity modulator 130 comprises: an optical holder 180 for a grating, the optical holder being electronically controlled and movable in a third spatial dimension 103; and a grating 1 according to the first aspect, arranged in the optical holder for providing the intensity modulation to the light profile.

Typically two or more phases are applied for different recordings to enable determination of an optical parameter. Also typically, each phase shift corresponds to a displacement of the modulation by a distance corresponding to the period of the modulation divided by the number n of recordings.

It may be preferable to have the light intensity modulator located as close to the sample as possible, to preserve the spatial modulation until the modulated light sheet enters the sample. This is inherently achieved by the approach where the light intensity modulator is an imprint on the container for the sample.

The holder 145 for the sample 140 of the medium is configured to enable the intensity modulated light sheet to illuminate the sample. For example, the holder may be located in relation to the light intensity modulator and the light sheet generator such that, when the sample is provided at the holder, the intensity modulated light sheet illuminates the sample.

Typically, the entire intensity modulated light sheet illuminates the sample, but some embodiments may apply a solution where only part of the intensity modulated light sheet illuminates the sample.

Preferably, the holder is configured such that the illumination of the sample is close to a side 141 of the sample that faces the optical sensor 162. This decreases the distance for the primarily scattered light (i.e., the single light scattering) to travel through the sample to reach the optical sensor.

The holder may, for example, be a stand for receiving the sample. The sample may be provided in a container as e.g. a cuvette transparent to the light/radiation used.

The optical sensor 162 is configured to record (over the light spectrum) intensity of light exiting the sample. The recorded intensity can then be used to determine the one or more optical parameters.

Typically, the optical sensor may be a camera (e.g., a charge-coupled device—CCD—camera or a scientific complementary metal-oxide-semiconductor—sCMOS—camera).

The optical sensor 162 is configured to record the intensity of light exiting the sample opposite to the illumination (so called transmitted light, illustrated as 194 in FIG. 1) and/or to record the intensity of light exiting the sample substantially orthogonal to the light sheet (scattered or photoluminescence light, illustrated as 195 in FIG. 1).

Recording the intensity of light 195 exiting the sample substantially orthogonal to the light sheet may be achieved by placing the optical sensor such that a straight line through the sample and the optical sensor is substantially orthogonal to the light sheet, i.e., extends in the third dimension. This is illustrated by the optical sensor placement 162 in FIG. 1b.

Recording the intensity of light 194 exiting the sample opposite to the illumination may, be achieved by letting the assembly further comprise an optical reflector 150 in the propagation path of the light sheet along the second spatial dimension, where the optical reflector is configured to reflect the light 194 of the intensity modulated light sheet exiting the sample opposite to the illumination towards the optical sensor 162. Such an approach is illustrated in FIG. 1b. The reflector may, for example, be a mirror or a diffusive glass layer.

According to this approach, a single, stationary optical sensor may be used for recording of the intensity of light exiting the sample opposite to the illumination and the intensity of light exiting the sample substantially orthogonal to the light sheet; possibly in a single recording.

In some embodiments, this approach may further comprise an attenuator (e.g., a neutral density filter) or amplifier in the light path between the reflector and the optical sensor, to provide the light exiting the sample opposite to the illumination and the light exiting the sample substantially orthogonal to the light sheet at similar intensity at the optical sensor. This avoids saturating the optical sensor while enabling recording of relatively small intensity variations. Other ways to avoid saturating the optical sensor while enabling recording of relatively small intensity variations include recording of the intensity of light exiting the sample opposite to the illumination and the intensity of light exiting the sample substantially orthogonal to the light sheet in different recordings and varying the optical sensor exposure time and/or the light source intensity between recordings.

When recording the intensity of light 195 exiting the sample substantially orthogonal to the light sheet (optical sensor placement 162) the optical sensor may typically be able to measure light intensity variations along an entire “width” 142 of the sample (“width” being an extension in the second dimension).

In some embodiments, the optical sensor recording the intensity of light exiting the sample substantially orthogonal to the light sheet may be further configured to switch between recording light intensity variations along the entire width 142 of the sample and recording light intensity variations along a part of the width of the sample. The part is typically the part closest to the illumination of the sample. In some embodiments, the optical sensor may be configured to vary the size of the part. This feature may be achieved, for example, by use of a zooming function for the optical sensor, e.g., an objective lens, a telocentric objective, a zoom lens, or similar.

In connection to this approach of recording light intensity variations along a part of the width of the sample, it may be beneficial to let the assembly comprise a light sheet resizer (RS) 135, configured to provide the intensity modulated light sheet in one of a plurality of available extensions in the first spatial dimension (e.g., in one of a plurality of available sizes or scales). This is illustrated in part (a) of FIG. 1 as the light sheet resizer shrinking the initial intensity modulated light sheet 193 to provide a resized intensity modulated light sheet 193a that has a smaller extension in the first spatial dimension. Thus, when the optical sensor zooms in to a part of the width of the sample (and inherently to a part of the “height” of the sample, “height” being an extension in the second dimension), the resized intensity modulated light sheet 193a may be formed such that it can still be recorded in entirety by the optical sensor. The light sheet resizer 135 may, for example, be implemented by suitable application of one or more lenses and a Fourier filtering.

With reference to FIGS. 2a-2c the principle behind the herein disclosed method will be explained further. To determine particle size in suspension, two different modulation frequencies are used to determine the size. This is possible due to the different scattering properties of particles of different sizes. FIG. 2a shows the signal intensity as a function of penetration length through a sample with suspended particles of three different sizes suspended in fluid. In FIGS. 2a-2c the relationship between the three particle sizes are d3>d2>d1. The frequency fq2 is higher than fq1. The full line is the theoretical extinction of the signal according to Beer Lamberts law. As can be seen the bigger the particle is the bigger is the deviation from Beer Lamberts law at the lower frequency fq1, but for a high frequency fq2, also big particles are close to the theoretical value according to Beer Lamberts law. By using a frequency high enough the line for fq2 in FIG. 2C can be almost horizontal indicating that the extinction follows Beer Lamberts law for all particle sizes. For increased accuracy measurements can be made at more than two frequencies.

FIG. 2b shows the signal intensity disclosed in FIG. 2a but on a logarithmic scale for the two frequencies. FIG. 2c is a plot of the linear regression coefficients of the lines disclosed in FIG. 2b. From the linear regression coefficients at two different frequencies a calibration to size can be made using particles of known size in suspension. The calibration is then used to determine size of the particles in suspension in the herein disclosed method.

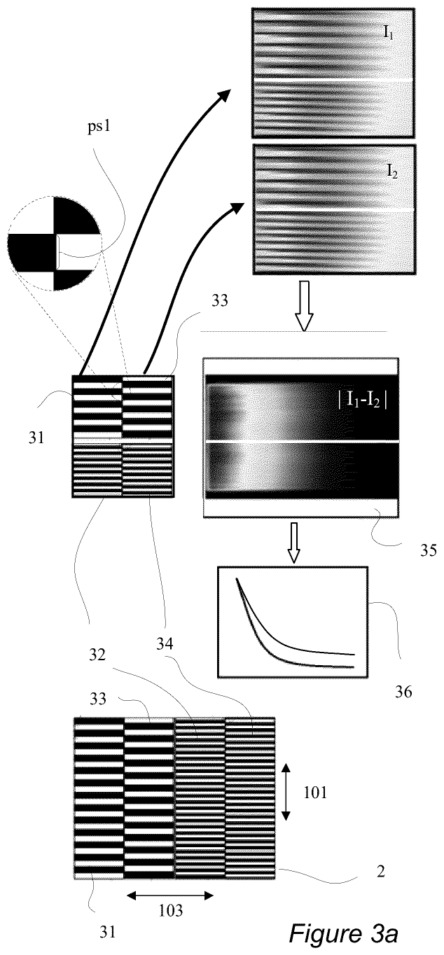

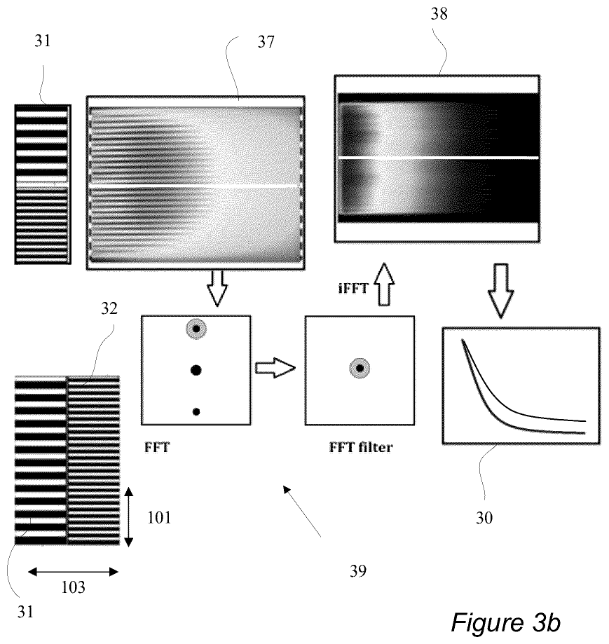

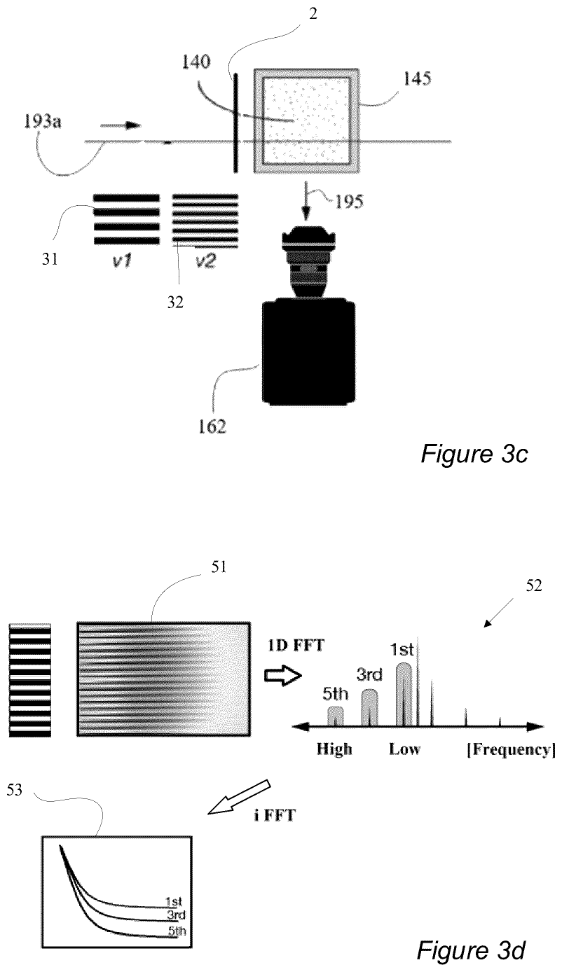

FIG. 3a illustrates the method of the present disclosure by measuring the extinction coefficient at two different frequencies by use of the first masks 31, 33 and the second masks 32, 34 by sequential phase shift of the first masks 31, 33 and the second masks 32, 34 respectively. The side scattering is imaged using a camera as shown in FIG. 3c. The recorded images of two phases are subtracted to reveal only the scattered light and the extinction of the light through the sample can be calculated as depicted in the resulting plot 36. In FIG. 3a the top half of the captured images 11, 12 a has a first modulation frequency v1 and the bottom half of the image has the second modulation frequency v2. In the plot 36, the two extinction from each of the two frequencies are illustrated. As discussed above, the lower of the curves (with higher extinction) is a higher modulation frequency with a curve closer to the theoretical Beer Lamberts Law, and the curve higher up is the extinction measured at a lower modulation frequency. The difference (image 35) between the first measured extinction (image 11) for the first masks 31,33 of a first frequency v1 and the second measured extinction (image 12) for the second masks 32, 34 of a second frequency v2 are used to calculate the extinction and particle size as discussed in connection with FIGS. 2a-2c.

FIG. 3b illustrates the method of the present disclosure by measuring the extinction coefficient at two different frequencies by a single mask per frequency, 2D imaging of side scattering and FFT analysis 39 to extract the extinction coefficient from e.g. the first harmonic.

FIG. 3d is a schematic illustration of the present disclosure by measuring the extinction coefficient at a single frequency and phase by a single mask, 2D imaging of side scattering and FFT analysis to extract the extinction coefficient from the first and second harmonic. As a single mask is used no moving parts are needed. The measurement can be made close to instantaneously. A 2D image 51 of side scattering from the modulated light propagating through suspended particles is captured by the camera. The harmonics are extracted using a one-dimensional Fast Fourier Transform as illustrated in image 52. Each of the 1^{st}, 3^{rd} and 5^{th} harmonics are isolated and inverse Fast Fourier Transformed back to an image where the extinction for three different frequencies thereby can be calculated, as illustrated in image 53, and used to calculate the particle size of the sample of suspended particles in line with the theory explained in connection to FIGS. 2a to 2c.

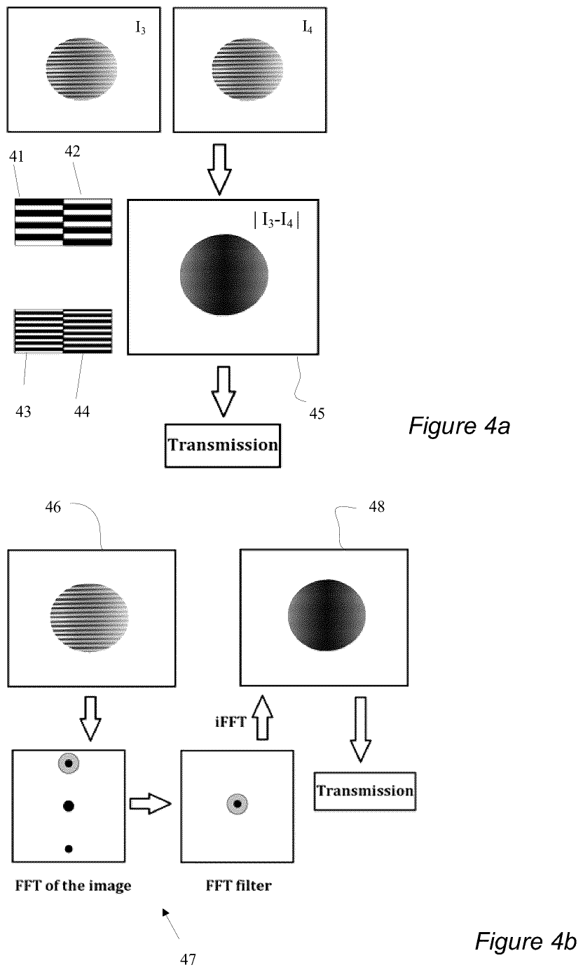

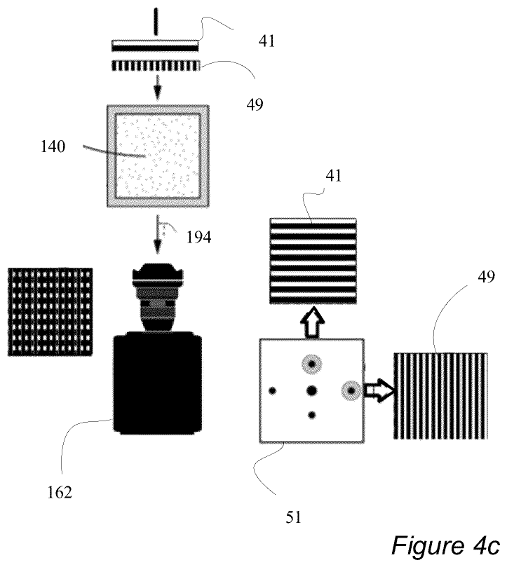

FIG. 4a illustrates the method of the present disclosure by measuring the extinction coefficient at two different frequencies by sequential phase shift, imaging of transmitted and forward scattered light and subtraction of the images. As seen, the method uses two phases of each frequency of the masks 41, 42, 43, 44, where the phases are shifted 180 degrees (or pi radians) between 41 and 42 and between 43 and 44, respectively. The light profile of the transmitted light through the sample for a single measurement is depicted in the plot 45, where the light is modulated using the first mask 41. A subsequent second measurement is then performed using the second mask 42 and subtracted from the first measurement to calculate the extinction coefficient for the first frequency. The same operation is repeated for the masks 43 and 44 of a second frequency in the modulation to be able to estimate the particle size. To calculate the extinction the measurements are compared to reference image without particles (not shown).

FIGS. 4b and 4c illustrates the method of the present disclosure by measuring the extinction coefficient at two different frequencies by a single mask per frequency, imaging of transmitted and forward scattered light and FFT analysis to extract the extinction coefficient from the first harmonic. The masks 43, 44 are used sequentially. The camera can however remain in exposure mode for capturing the transmission with both masks 43,44 so that the measurement can be made in one shot and the particle calculation can be made with only one camera exposure. Close to instantaneous measurements of particle size in a suspension can thereby be made, wherein the delay is only dependent on the speed of the calculations and time to shift the masks 43, 44.

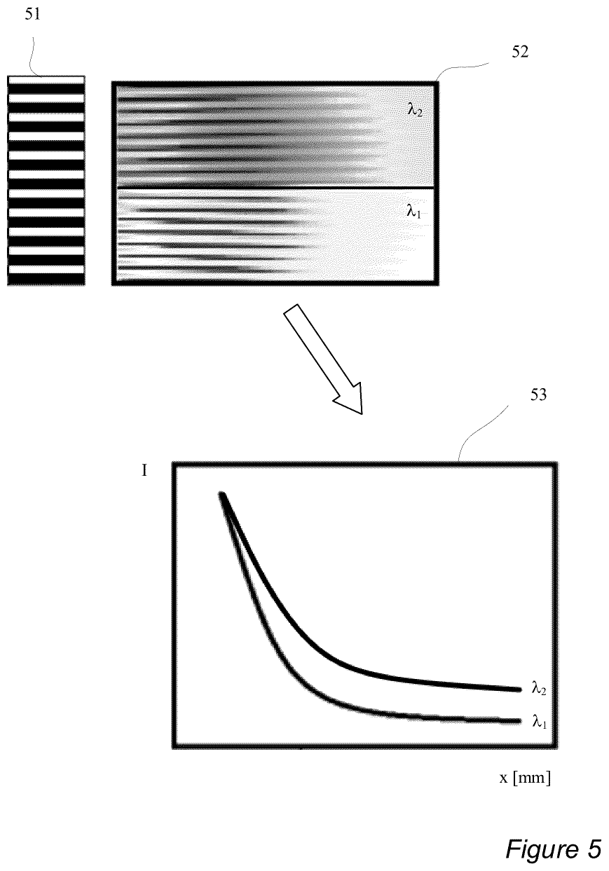

FIG. 5 illustrates the method of the present disclosure by measuring the extinction coefficient using modulated light of a single frequency but at two different wavelengths on particles smaller than 1 micrometer. Small particles will scatter light with Rayleigh scattering. A 2D imaging 52 of side scattering is recorded. The setup used has a sample and a camera in an equivalent way as in FIG. 3c. In FIG. 5 a light sheet divided into two colors, where, e.g. the top half is red and the bottom half is blue is propagating through the mask 51 being a Ronchi grating with one frequency. The light sheet propagates through the sample and an image of the side scattering 52 is recorded with a camera. An example of a 2D image 52 of the side scattering is shown in the figure where the top half is red, 21, and the bottom half is blue, 22. The extinction of each half of the image is calculated and displayed in the extinction image 53 illustrating that the light with a longer wavelength, 21, has a lower extinction than the light of a shorter wavelength, 22. As seen in the intensity I of the side scattering of the shorter wavelength, 21, e.g. blue, decreases quicker with the distance through the sample.

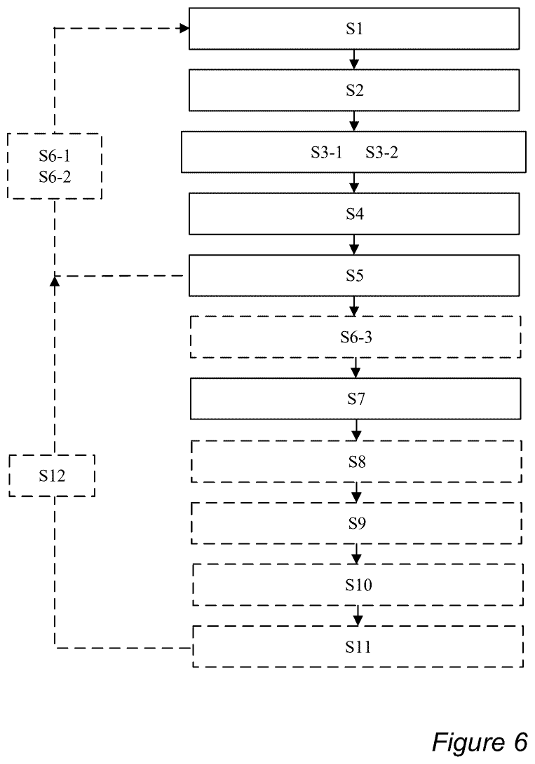

Now with reference to FIG. 6 the first aspect of this disclosure will be described. A method for measuring particle size of particles suspended in a fluid, the method comprising modulating S1 radiation with a periodic wave optical mask; illuminating S2 the fluid with the modulated radiation; detecting scattered radiation and/or transmitted radiation S3-1 with a 2D detector capturing an image at a first modulation frequency; detecting scattered radiation and/or transmitted radiation S3-2 with a 2D detector capturing an image at a second modulation frequency; extracting S4 a first image for the first modulation frequency and a second image for the second modulation frequency, respectively; calculating S5 a first extinction coefficient for the first modulation frequency and the second modulation frequency, respectively, based on the first extracted image and the second extracted image, respectively; determining the size S7 of the suspended particles based on the relationship between the first calculated extinction coefficient and the second calculated extinction coefficient.

The variation between extinction coefficients at different frequencies is determined by the size of the suspended particles.

The frequencies used in the optical mask is chosen after roughly estimate size of the particles. Small particles require higher frequencies than larger particles.

The method is based on the fact that small particles blur the modulation more rapidly with distance than large particles. The method “sees” this as though the extinction is greater. By changing the modulation frequency it is observed how the extinction coefficient changes; if it remains the same the particles are small, if it changes, the particles are large. The size can then be estimated based on the change in extinction coefficient with modulation frequency and a pre-calibrated calibration curve or calibration table.

The detected side scattering is preferably measured from the side, as shown in FIG. 3c, and could also include fluorescence. The transmitted radiation is preferably measured in the forward direction of the illuminating radiation, as shown in FIG. 4c, and could also include forward scattered radiation.

The following method steps S6-S12 are drawn with dashed lines in FIG. 5, indicated that the steps are optional and refereeing to different detailed embodiments.

According to some embodiments the method further comprises calculating a true extinction coefficient S8 based on the first calculated extinction coefficient and the second calculated extinction coefficient; estimating the number density S9 of the suspended particles based on the determined size of the suspended particles and the true extinction coefficient.

According to some embodiments the method further comprises calculating the Total Suspended Solids Volume TSSV S10 of the suspended particles based on the estimated number density and the determined size of the suspended particles.

According to some embodiments the method further comprises calculating the dry weight S11 based on the TSSV and the density of the particles.

According to some embodiments the method further comprises repeating S12 the method multiple times over time to measure the particle sedimentation and estimate the density based on the particle sedimentation.

Referring to FIGS. 3a, 3b, 3c, 4a, 4b and 4c the periodic wave optical mask is comprised in the group consisting of: square wave mask; sine wave mask or a diffractive optical elements.

According to some embodiments the method further comprises generating S6-1 the multiple modulation frequencies by illuminating multiple masks with different modulation frequencies sequentially. The multiples masks 31-34, 41 are placed on the same base plate 2, wherein the method further comprises moving the base plate S6-2 to sequentially shift the mask used for modulating the radiation.

According to an alternative embodiment the method further comprises generating S6-3 the multiple modulation frequencies by extracting different harmonics in the modulation. When measuring side-scattering detected from the side by the 2D detector the mask is a square wave mask and wherein the harmonics are separated by a one-dimensional power spectrum and spatial lock-in analysis, as disclosed in FIGS. 3b and 4b.

With reference to FIG. 4c, when measuring forward-scattering detected by the 2D-detector along the radiation propagation direction after the liquid, the mask is a square wave mask 41, 49 and the harmonics are separated by a two-dimensional power spectrum and spatial lock-in analysis. The graph 51 in the bottom of FIG. 4c illustrates a 2D power spectrum an lock-in analysis. As seen in FIG. 4c the gratings 41, 49 are placed perpendicular to each other so as to effectively form a square mask. In some embodiments the gratings 41 and 49 are integrated in one square mask grating. The result is that the diffraction due to the different gratings will be in perpendicular directions so that when an FFT analysis is made on the image, the first harmonic of the mask 49 will end up in the horizontal plane, while the first harmonic from the perpendicular mask 41 will end up in the vertical plane as depicted in the graph 51.

As discussed above, the disclosed method of measuring particle size of particles suspended in a fluid can be done by measuring either side scattering or transmitted radiation. When measuring side scattering, as shown in FIGS. 3a-3c, the method could either be performed by sequential illumination of a mask that is shifted to sequentially shift the frequency used to achieve the disclosed method. Or the multiple frequencies may be recorded from a single captured picture by extracting harmonics resulting from a square wave mask. The harmonics are separated through a spatial lock-in and a lock-in analysis on the resulting 1D power spectrum.

When measuring transmitted radiation, as shown in FIG. 4a-4c, the method could either be performed by sequential illumination of a mask that is shifted to sequentially shift the frequency used to achieve the disclosed method. Or the multiple frequencies may be recorded from a single captured picture by extracting harmonics resulting from a square wave mask. The harmonics are separated through a spatial lock-in and a lock-in analysis on the resulting 2D power spectrum.

With reference to FIGS. 1a, 1b, 3c, and 4c, the second aspect of this disclosure shows an assembly for measuring particle size of particles suspended in a fluid 140, the assembly comprising: a radiation profile generator the first aspect configured to provide a radiation profile, wherein the radiation profile has a propagation path in a second spatial dimension 102; a periodic wave optical mask arranged to modulate the radiation profile; a holder 145 for a sample of suspended particles 140, configured to enable the intensity modulated radiation sheet to illuminate the sample; and a 2D detector 162 arranged to capture at last one 2D image for each of a plurality of modulation frequencies; wherein the assembly is arranged to perform the method according to the first aspect. The radiation profile generator is configured to provide a radiation sheet 192, comprising a radiation spectrum extending in a first spatial dimension 101.

The person skilled in the art realizes that the present disclosure is not limited to the preferred embodiments described above. The person skilled in the art further realizes that modifications and variations are possible within the scope of the appended claims. For example, the detector is disclosed as a camera in FIGS. 3c and 4c, but a person skilled in the art realizes that any equivalent sensor can be used. The person skilled in the art further realizes that the example equations disclosed may be altered in various ways with similar result, still performing the method as described in the claims. Additionally, variations to the disclosed embodiments can be understood and effected by the skilled person in practicing the claimed disclosure, from a study of the drawings, the disclosure, and the appended claims.

1. A method for measuring particle size of particles suspended in a fluid,
the method comprising
modulating (S1) radiation with a periodic wave optical mask;
illuminating (S2) the fluid with the modulated radiation;
detecting scattered radiation and/or transmitted radiation (S3-1) with a 2D detector capturing an image at a first modulation frequency;
detecting scattered radiation and/or transmitted radiation (S3-2) with a 2D detector capturing an image at a second modulation frequency;
extracting (S4) a first image for the first modulation frequency and a second image for the second modulation frequency, respectively;
calculating(S5) a first extinction coefficient for the first modulation frequency and the second modulation frequency, respectively, based on the first extracted image and the second extracted image, respectively;
determining the size (S7) of the suspended particles based on a relationship between the first calculated extinction coefficient and the second calculated extinction coefficient.

2. The method according to claim 1, wherein the method further comprises:
calculating a true extinction coefficient (S8) based on the first calculated extinction coefficient and the second calculated extinction coefficient;
estimating a number density (S9) of the suspended particles based on the determined size of the suspended particles and the true extinction coefficient.

3. The method according to claim 2, wherein the method further comprises:
calculating a Total Suspended Solids Volume (TSSV) (S10) of the suspended particles based on the estimated number density and the determined size of the suspended particles.

4. The method according to claim 3, further comprising calculating a dry weight (S11) based on the TSSV and the density of the particles.

5. The method according to claim 1, further comprising repeating (S12) the method multiple times over time to measure a particle sedimentation and estimate the density based on the particle sedimentation.

6. The method according to claim 1, wherein the method further comprises generating (S6-1) the multiple modulation frequencies by illuminating multiple masks with different modulation frequencies sequentially.

7. The method according to claim 6, wherein the multiples masks are placed on the same base plate, the method further comprising: moving a base plate (S6-2) to sequentially shift the mask used for modulating the radiation.

8. The method according claim 1, wherein the method further comprises generating (S6-3) the multiple modulation frequencies by extracting different harmonics in the modulation.

9. The method according to claim 1, wherein the scattering is side-scattering detected from the side by the 2D detector.

10. The method according to claim 8, wherein the mask is a square wave mask and wherein the harmonics are separated by a one-dimensional power spectrum and spatial lock-in analysis.

11. The method according to claim 1, wherein the scattering is forward-scattering detected by a 2D-detector along a radiation propagation direction after a liquid.

12. The method according to claim 11, wherein the mask is a square wave mask and wherein the harmonics are separated by a two-dimensional power spectrum and spatial lock-in analysis.

13. A method for measuring particle size of particles suspended in a fluid, the method comprising
modulating (S1) radiation with a periodic wave optical mask;
illuminating (S2) the fluid with the modulated radiation;
detecting scattered radiation and/or transmitted radiation (S3-1) with a 2D detector capturing an image at a first radiation wavelength;
detecting scattered radiation and/or transmitted radiation (S3-2) with a 2D detector capturing an image at a second radiation wavelength;
extracting (S4) a first image for the first radiation wavelength and a second image for the second radiation wavelength, respectively;
calculating(S5) a first extinction coefficient for the first radiation wavelength and the radiation wavelength, respectively, based on the first extracted image and the second extracted image, respectively;
determining the size (S7) of the suspended particles based on the relationship between the first calculated extinction coefficient and the second calculated extinction coefficient.

14. An assembly for measuring particle size of particles suspended in a fluid, the assembly comprising:
a radiation profile generator configured to provide a radiation profile, wherein the radiation profile has a propagation path in a second spatial dimension
a periodic wave optical mask arranged to modulate the radiation profile;
a holder for a sample of a medium, configured to enable a intensity modulated radiation sheet to illuminate the sample; and
a 2D detector arranged to capture at last one 2D image of the illuminated sample;
wherein the assembly is arranged to perform the method according to claim 1.

15. The assembly according to claim 14, wherein the radiation profile generator is configured to provide a polychromatic radiation sheet comprising a radiation spectrum extending in a first spatial dimension.
